(19) United States
(12) Patent Application Publication
(10) Pub. No.: US 2016/0217040 A1
(43) Pub. Date: Jul. 28, 2016

(54) RAID PARITY STRIPE RECONSTRUCTION

(71) Applicant: AGENCY FOR SCIENCE, TECHNOLOGY AND RESEARCH, Singapore (SG)

(72) Inventors: Chao JIN, Singapore (SG); Weiya XI, Singapore (SG); Khai Leong YONG, Singapore (SG); Zhi Yong CHING, Singapore (SG); Feng HUO, Singapore (SG)

(73) Assignee: Agency for Science, Technology and Research, Singapore (SG)

(21) Appl. No.: 14/914,238

(22) PCT Filed: Aug. 27, 2014
(86) PCT No.: PCT/SG2014/000406

§ 371 Date: Feb. 24, 2016

(30) Foreign Application Priority Data
Aug. 27, 2013 (SG) 201306456-3

(51) Int. Cl. G06F 11/10; G06F 3/06

(52) U.S. Cl. CPC G06F 11/1088; G06F 3/0619; G06F 3/064; G06F 3/0689

(57) ABSTRACT

Data reconstruction in a RAID storage system, by determining if a parity stripe has been reconstructed and if the parity stripe has been allocated, by the checking of a reconstruction/rebuild table and a space allocation table. Before reconstruction of a parity stripe occurs, the non-volatile memory of a failed hybrid drive is checked to determine if it is accessible and if so the data is copied to the new hybrid drive instead of reconstruction occurring.

### CROSS-REFERENCE TO RELATED APPLICATION

This application claims the benefit of priority of Singapore patent application No. 201306456-3, filed Aug. 27, 2013, the content of which incorporated herein by reference in its entirety for all purposes.

### FIELD

Various embodiments disclosed herein relate to storage systems.

### BACKGROUND

The technology of Redundant Array of Independent Disks (RAID) has been widely used in storage systems to achieve high data performance and reliability. By maintaining redundant information within an array of disks, RAID can recover the data in case one or more disk failures occur in the array. RAID systems are classified into different levels according to their structures and characteristics. RAID level 0 (RAID0) has no redundant data and cannot recover from any disk failure. RAID level 1 (RAID1) implements mirroring on a pair of disks, and therefore can recover from one disk failure in the pair of disks. RAID level 4 (RAID4) and RAID level 5 (RAID5) implement XOR parity on an array of disks, and can recover from one disk failure in the array through XOR computation. RAID level 6 (RAID6) is able recover from any two concurrent disk failures in the disk array, and it can be implemented through various kinds of erasure codes, such as the Reed-Solomon codes.

The process of recovering data from disk failures in a RAID system is called data reconstruction. The data reconstruction process is very critical to both the performance and reliability of the RAID systems. Take the RAID5 system as an example, when a disk fails in the array, the array enters degraded mode, and user I/O requests falls on the failed disk have to reconstruct data on the fly, which is quite expensive and causes great performance overhead. Moreover, the user I/O processes and reconstruction process run concurrently and compete for the disk bandwidth with each other, which further degrades the system performance severely. On the other hand, when the RAID5 system is recovering from one disk failure, a second disk failure may occur, which will exceed the system's failure tolerance ability, and cause permanent data loss. Thus, a prolonged data reconstruction process will introduce a long period of system vulnerability, and severely degrade system reliability. Based on these reasons, the data reconstruction process should be shortened as much as possible, and seeking ways and methods to optimize the data reconstruction of current RAID systems is of great importance and significance.

For data reconstruction, an ideal scenario is offline reconstruction, in which the array stops serving the user I/O requests, and let the data reconstruction process run at its full speed. However, this scenario is not practical in most production environments, where the RAID systems are required to provide uninterrupted data services even when they are recovering from disk failures. In other words, RAID systems in production environments are doing online reconstruction, in which the reconstruction process and user I/O processes are running concurrently. In previous work, several methods have been proposed to optimize the reconstruction process of RAID systems. The Workout method aims to redirect the user write data cache popular read data to a surrogate RAID, and reclaim the write data to the original RAID when the reconstruction of original RAID completes. By doing so, Workout tries to separate the reconstruction process from the user I/O processes and leave the reconstruction process undisturbed. Different from Workout, our proposed methods let the user I/O processes cooperate with reconstruction process, and contribute to the data reconstruction while serving user read/write requests. Another previous method is called Victim Disk First (VDF). VDF defines the system DRAM cache policy that caches the data in the failed disk in higher priority, so that the performance overhead of reconstructing the failed data on the fly can be minimized. Different from VDF, our methods include a policy to optimize the reconstruction sequence by utilizing the data in the NVM caches of the surviving disks in the array. A third previous work is called live block recovery. The method of live block recovery aims to recover only live file system data during reconstruction, skipping the unused data blocks. However, this method relies on the passing of file system information to the RAID block level, and thus requires significant changes of existing file systems. Moreover, this method can only be applied to replication based RAID, such as RAID1, and cannot be applied to parity based RAID, such as RAID5 and RAID6. Our proposed method also aims at reconstruct only used data blocks, but our method works entirely at block level, and requires no modification to the file systems. Besides, our method can be applied to any RAID levels including parity based RAID systems.

Hybrid drive is a new kind of hard disk drive which places a spinning magnetic disk media together with a NVM cache inside one disk enclosure. In the normal mode, the NVM cache serves as a read/write cache for user I/O requests. In the reconstruction mode, the data in the NVM cache can be exploited to accelerate the reconstruction process. In the following description of our methods, we will illustrate how to optimize the reconstruction of RAID systems by exploiting NVM caches inside hybrid drives.

### SUMMARY

According to exemplary embodiments, methods for optimizing the reconstruction process of RAID systems composed of hybrid drives are disclosed. RAID5, for example, may be used as an example to illustrate the disclosed methods. It must be noted that, these methods can also be applied to other RAID levels such as, but not limited to RAID1, RAID4 and RAID6. Various methods in accordance with exemplary embodiments may include:
Fine-grained reconstruction control for each individual parity stripe.

A corresponding exemplary method is illustrated in FIG. 3, FIG. 4 and FIG. 5.
Fast reconstructing the data in the NVM cache of the failed hybrid drive through direct copying.

A corresponding exemplary method is illustrated in FIG. 6.
Skip reconstructing unused free space and the space holding invalid/useless data.

A corresponding exemplary method is illustrated in FIG. 7

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1 illustrates the workflow of user read/write processes of a typical RAID system in the normal mode according to one embodiment.

FIG. 2 illustrates the workflow of user read/write processes (on the failed disk) and the reconstruction process of a typical RAID system in the reconstruction mode according to one embodiment.

FIG. 3 illustrates the workflow of user read/write processes (on the failed disk) and the reconstruction process of a RAID system with bitmap based fine-grained reconstruction control according to one embodiment.

FIG. 4 illustrates the workflow of reconstruction process of a RAID system which schedules the reconstruction sequence according to the data in the NVM caches of the hybrid drives according to one embodiment.

FIG. 5 illustrates the workflow of user read/write processes (on the failed disk) of a RAID system with bitmap based fine-grained reconstruction control, where the corresponding data block has already been reconstructed according to one embodiment.

FIG. 6 illustrates the reconstruction process of directly copying the data in the NVM cache of the failed hybrid drive to the replacing disk according to one embodiment.

FIG. 7 illustrates the reconstruction process of a RAID system with a bitmap to indicate the used and unused space in the system, in which only the used space are reconstructed, and the unused space are skipped according to one embodiment.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other method or device. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element includes a reference to one or more of the features or elements.

In the context of various embodiments, the phrase “at least substantially” may include “exactly” and a reasonable variance.

In the context of various embodiments, the term “about” or “approximately” as applied to a numeric value encompasses the exact value and a reasonable variance.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

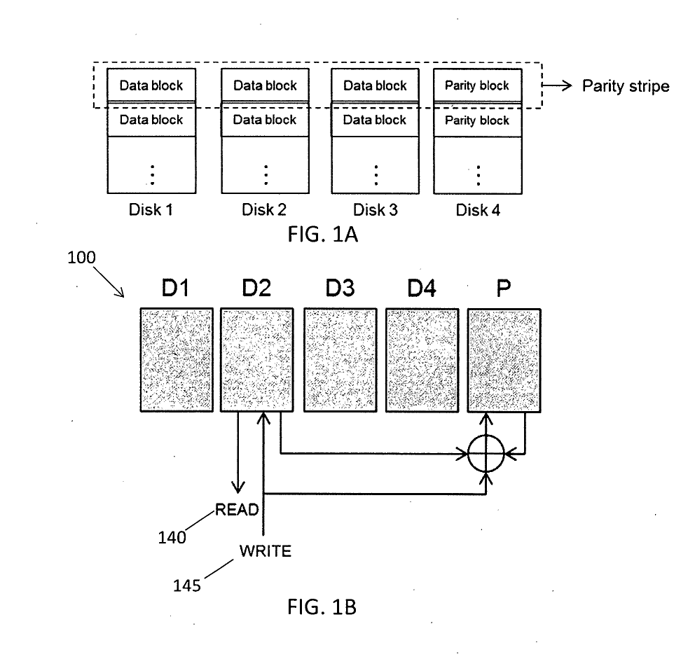

In accordance with exemplary embodiments, a parity stripe may refer to a unit for parity RAID systems to organize data. As shown in FIG. 1A, a parity stripe may be composed of multiple blocks.

Each block of a parity stripe may reside in a different disk. As show in the example of FIG. 1A, the parity blocks of the enclosed first parity stripe reside over storage disks 1-4.

A block in a parity stripe may either be a data block or a parity block with a typical size of approximately 4 KB. A data block can hold user data. A parity block can hold parity value(s) computed from the data blocks of the parity stripe according to certain parity algorithm, which may uses XOR computation.

FIG. 1B shows according to an exemplary embodiment, how a typical (e.g., un-optimized) RAID system 100 handles the user read/write requests (140, 145). For read requests, the read processes read data directly from the data disks (D1, D2, D3, D4) and send it back to users. For write requests, the write processes first read out the old data and its corresponding parity, and use them together with the new data to generate the new parity, and then write the new data and new parity to the data and parity disks (D1, D2, D3, D4, P1).

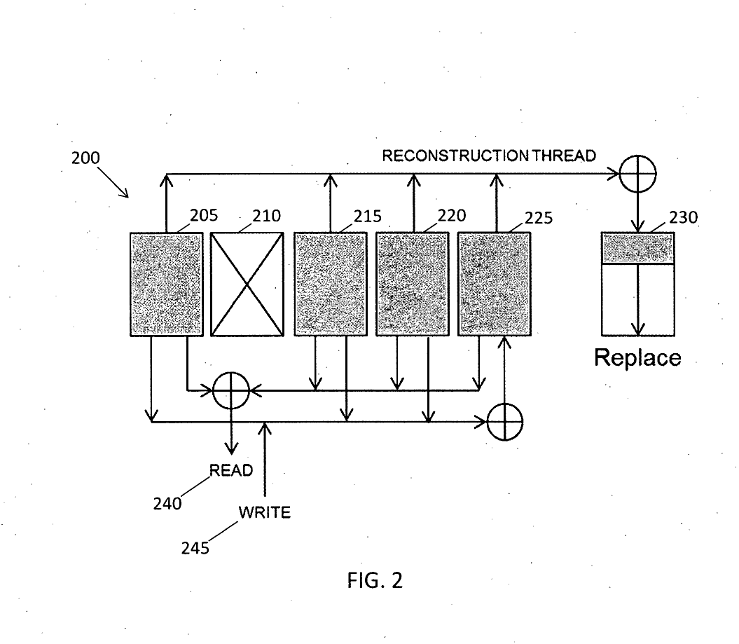

FIG. 2 shows according to an exemplary embodiment, how a typical RAID system 200 does the online reconstruction when a disk fails. The reconstruction process may reconstruct the parity stripes of the RAID system 200 sequentially from the first to the last parity stripe. To construct each parity stripe, the reconstruction process may reads out the corresponding data and parity blocks from the surviving disks (205, 215, 220, 225), regenerates the data block on a failed disk 210 through parity computation, and writes the data block back to a replacing disk 230. During the online reconstruction, user I/O requests (240, 245) which fall onto the failed disk have to reconstruct the data on the fly. For a read request 240, all the other data and parity blocks in the parity group will be read out and the requested data will be reconstructed through parity computation. For a write request 245, all the other data blocks expect the parity block will be read out, then the new parity block will be reconstructed and written back to the parity disk. Therefore, the user I/O processing in the reconstruction mode is more complicated and has lower performance than in the normal mode. It must be noted that, the reconstruction process and the user I/O processes are running separately from each other, and the user I/O processing will not return to normal mode until the entire failed disk are reconstructed. We refer to this scheme as coarse-grained reconstruction control.

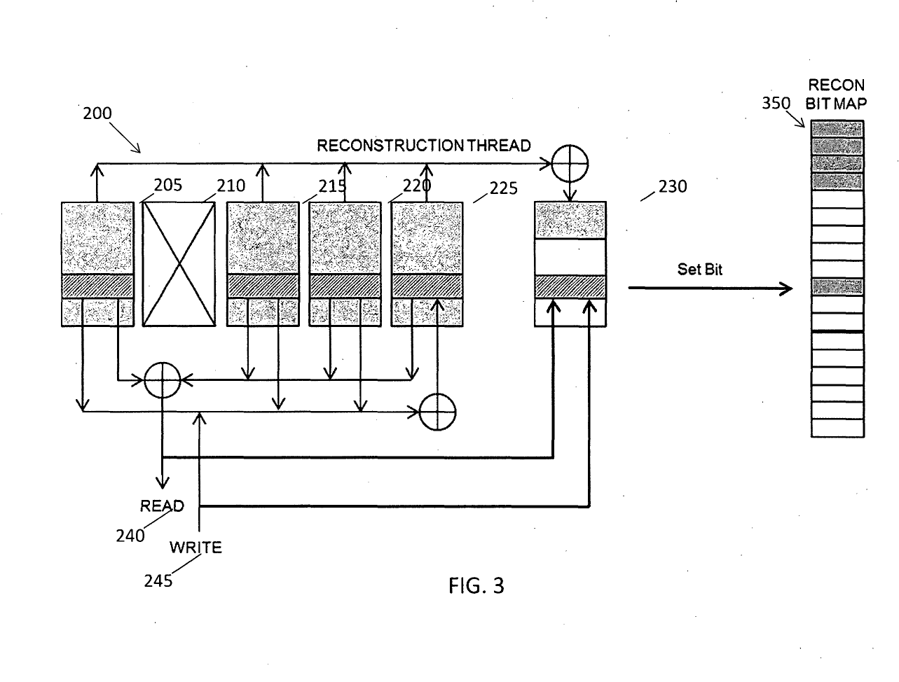

FIG. 3 shows according to an exemplary embodiment, a RAID system 300 using a bitmap based fine-grained reconstruction control. On the start of reconstruction, a bitmap (RECON BITMAP 350) is setup to record the reconstruction status of each individual parity stripes. The bitmap 350 is initially set to all zero, and when a parity stripe is reconstructed, its corresponding bit in the bitmap is set to one. Different from the coarse-grained reconstruction control, which requires the reconstruction to be done in strictly sequential order, the bitmap based fine-grained reconstruction control allows the reconstruction of the parity stripes to be done in any order. Under the fine-grained reconstruction control, the user I/O processes cooperate with the reconstruction process. When a user I/O process requests for a failed data block that has not been reconstructed, the failed block will be reconstructed on the fly and written back to a replacing disk 230. Then, the corresponding bit of this block in the bitmap is set to one, indicating that this failed block has been reconstructed. On the other hand, the reconstruction process still runs sequentially from the first to the last parity stripe. However, before reconstructing a parity stripe, the reconstruction process will check the bitmap to see if the corresponding bit has been set or not. If the bit has been set, the reconstruction process will skip reconstructing this parity stripe.

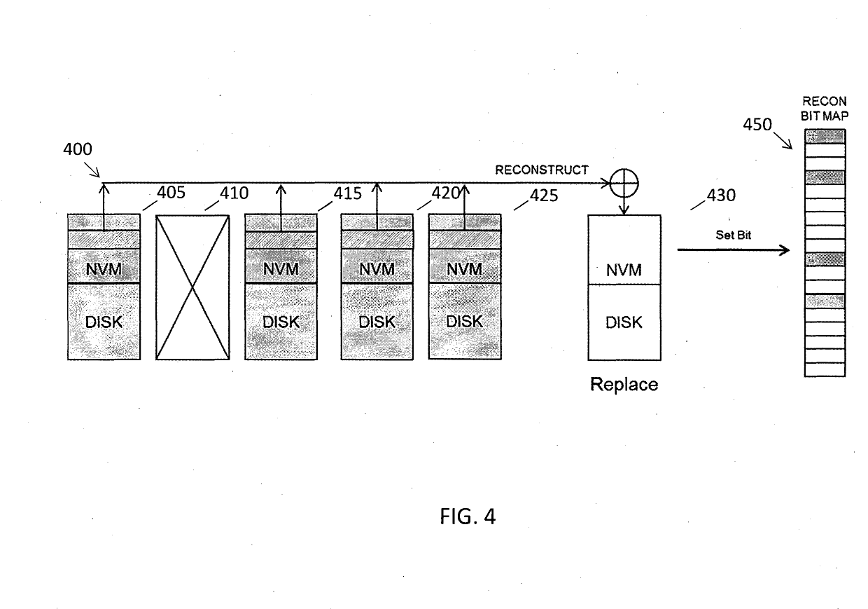

FIG. 4 shows according to an exemplary embodiment, utilizing data in NVM cache of the hybrid drives (405, 410, 415, 420, 425, 430) to optimize the reconstruction sequence. To reconstruct a failed block, the reconstruction process needs to read out all the other data and parity blocks in the same parity stripe. Since reading data from NVM cache is much faster than reading data from the spinning disk, and data stored in the NV cache are the hot and/or important data, it will be more efficient to reconstruct a parity stripe if all or most of its data and parity blocks have been cached in the NVM caches of the surviving disks (405, 415, 420, 425). Therefore, the reconstruction process first scans through the NVM caches of the hybrid drives, and reconstruct the parity stripes which have more data and parity blocks cached in the NVM in higher priority than other parity stripes. For the parity stripes which have just part of their parity blocks cached in the NVM, additional optimization can be made to hint the NVM cache management module to prefetch the uncached parity blocks into the NVM cache for subsequent reconstruction use. When the parity stripes are reconstructed, their corresponding bits are set in the reconstruction bitmap (RECON BITMAP 350).

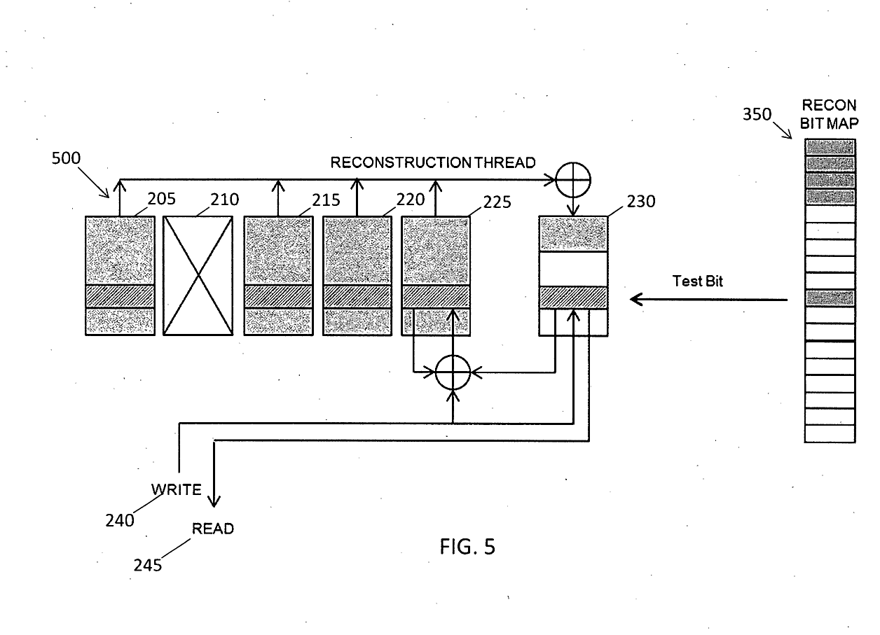

FIG. 5 shows according to an exemplary embodiment processing of user I/O requests under the bitmap based fine-grained reconstruction control. As shown in FIG. 3, when the user request falls on a failed data block that has not been reconstructed, the data block (for a read request 240) or the parity block (for a write request 245) will be reconstructed on the fly, and it requires all the surviving disks (205, 215, 220, 225) in the parity stripes to be accessed, which is quite expensive. Under the coarse-grained reconstruction control, all the user I/O requests will be processed in this expensive way until the reconstruction process completes. However, under the fine-grained reconstruction control, the user I/O requests can be processed according to the reconstruction status of each individual parity stripe. As shown in FIG. 5, if the user I/O request falls on a failed block that has already been reconstructed, the request will be processed the same as the normal mode shown in FIG. 1.

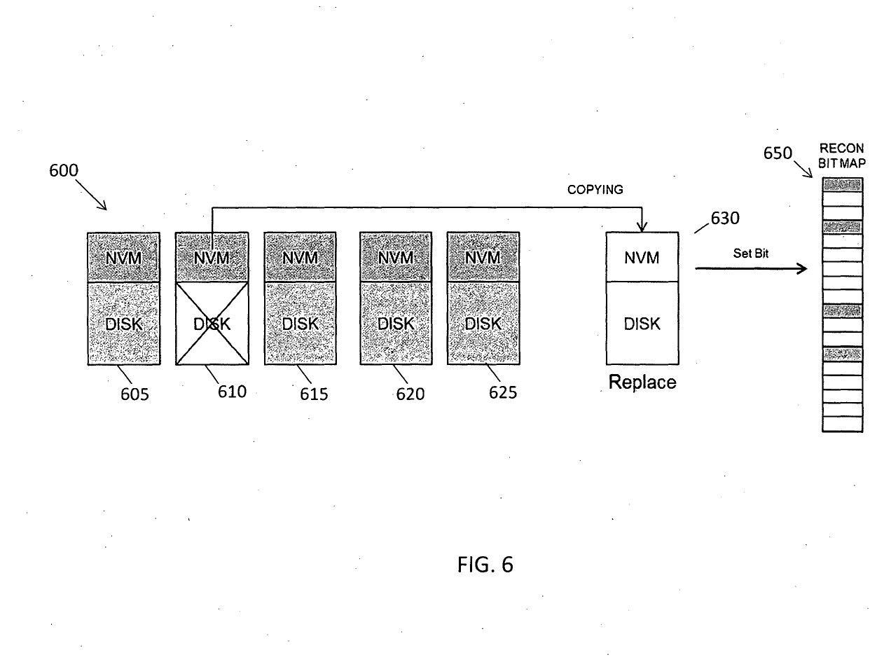

FIG. 6 shows according to an exemplary embodiment a method of reconstructing the data cached in NVM cache of the failed hybrid drive through direct copying. In a practical RAID system 600, a disk failure is usually caused by the read/write errors of the spinning disk media. Therefore, when a hybrid drive 410 fails, its NVM cache may still be accessible. On the start of reconstruction, the RAID system first detects if the NVM cache of the failed hybrid drive 410 is still accessible. If the NVM cache is accessible, the data blocks in it is read out and copied to the replacing disk, then their corresponding bits in the reconstruction bitmap are set and they are marked as reconstructed. In this way, the data blocks in the NVM cache are constructed in a straightforward way that is more efficient than the parity-computation way. Moreover, the data blocks cached in the NVM cache are usually hot data, and are accessed by a large proportion of user requests. When they are reconstructed, the user requests on these data blocks can be processed more efficiently.

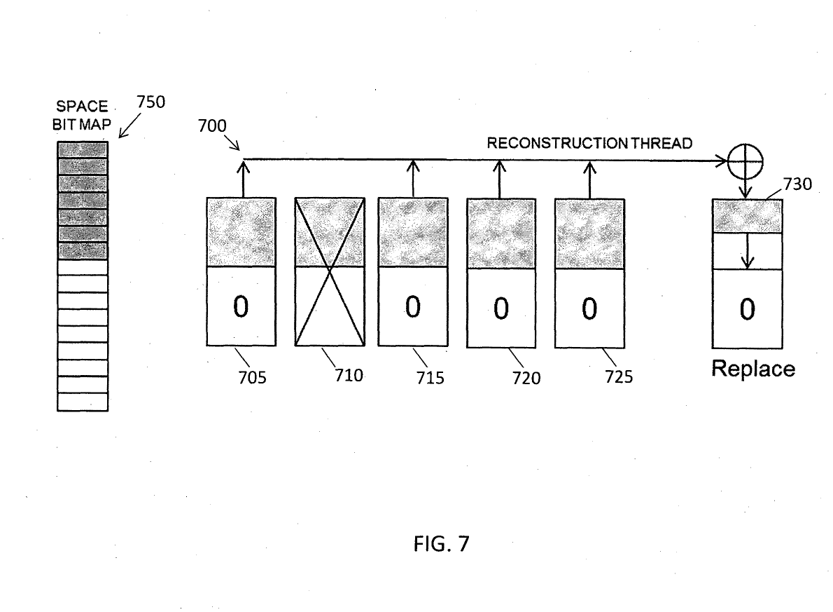

FIG. 7 shows according to an exemplary embodiment a method of shortening the total reconstruction time by reconstructing only the used space of the RAID system. A space bitmap 750 is setup to record the allocated/free status of each parity stripe. To reduce the size of the space bitmap 750, multiple parity stripes can be regarded as a unit, and correspond to one same bit in the bitmap. On the creation of the RAID system 700, the synchronization is done through writing zero to all the data and parity disks (705, 710, 715, 720, 725). The content of the replacing disk 730 is also initialized to zero in the background. The space bitmap 750 is initialized to be all zero. When a parity stripe is allocated for the first time, its corresponding bit in the space bitmap 750 is set to one. During reconstruction, the reconstruction process checks the space bitmap 750 before it reconstructs a particular parity stripe. If the bit has been set, the parity stripe should have been allocated and must be reconstructed; otherwise, the parity stripe should be free and contains only zero blocks, and therefore does not need to be reconstructed. It must be noted that, the space bitmap 750 is implemented at the block level, and does not require modifications to the above file systems. However, in order for the space bitmap 750 to be optimally used, the file system may support a trim-like command, and when it frees a previously allocated parity stripe, it can inform the RAID system 700. The RAID system 700 will write the parity stripe back to zero in the background, and then unset the corresponding bit in the space bitmap.

In accordance with exemplary embodiments, a space bitmap may be initialized at the start of data reconstruction that is after RAID creation. That is, when a data reconstruction process for a RAID system begins, the parity block for each parity stripe to be constructed reconstruction can be checked. If the parity block is all zero, the space bitmap can be updated so as to indicate that the associated parity stripe is unused. If it is not all zero, the bitmap can be updated to indicate that the associated parity stripe is used.

For example, during a RAID creation process, all the data and parity block in the RAID system may be initialized to zero blocks. Thus if a parity stripe is used, its parity block must be updated and thus can become non-zero. However if a parity stripe is never used, its parity block may remain as an all-zero block.

In some exemplary embodiments, as previously disclosed, the parity blocks of associated parity stripes can be checked on the fly during reconstruction. Therefore, a space bitmap may not be used to indicate whether a parity stripe has been used or unused. In response to the on the fly checking of the parity blocks of the parity stripe for reconstruction, the parity stripe can be reconstructed by writing a zero to the replacement disk if the parity block is zero. If the parity block is not all zero, the reconstruction process can proceed in accordance with embodiments herein.

In accordance with exemplary embodiments, systems and methods for optimizing a reconstruction process in a RAID system with either conventional HDDs or hybrid HDDs are disclosed herein.

In accordance with exemplary embodiments, one or more bitmaps (e.g., metadata recording mechanism) may be used for reconstruction scheduling, reading/writing data, and even data caching after a disk drive failed and reconstruction process started. In exemplary embodiments two bitmaps may be built or generated at the start of a data reconstruction process. For example, one bitmap that may be used is a reconstruction bitmap, in which each bit represents the reconstruction status of a parity stripe. The reconstruction bitmap may be initialized to be all-zero, and when a parity stripe is reconstructed, a corresponding bit of the bitmap is set a 1.

Similarly, another bitmap that may be used for data reconstruction is a space bitmap, in which each bit represents whether a parity stripe (or a group of parity stripes) used or not. For example, if a parity stripe is determined or identified as previously used, a typical normal reconstruction process proceeds. Otherwise, reconstruction the parity stripe may consist of simply writing a zero to the replacement drive/disk.

In accordance with exemplary embodiments, bitmaps used in the reconstruction process may be kept in volatile memory such as system memory or NVM or any other fast access storage space.

In accordance with exemplary embodiments, a reconstruction scheduler, in a data reconstruction process, may use bitmap information and/or other information to determine a reconstruction sequence and/or how to reconstruct each parity stripe.

In accordance with exemplary embodiments, scheduling strategy to optimize a data reconstruction process in RAID system with conventional hard disk drives (HDDs) may include:

1. Determining, if there is no request sent from any applications, and if not, a reconstruction scheduler starts to schedule the reconstruction process by checking from a 1st bit in the reconstruction bitmap (associated with a 1st parity stripe). If it is 0 (indicating the parity stripe associated with the bit has not been reconstructed), the reconstruction scheduler will issue the commands to reconstruct the 1st parity stripe. The reconstruction scheduler may further check the 1st bit in the space bitmap. If it is 0 (indicating the parity stripe associated with the checked has not been used or allocated and contains all zero), the parity stripe may be reconstructed by writing zero to the replacement disk. Otherwise if the checked bit of the space bitmap is 1 (indicating it has been used/allocated), the parity stripe associate with the checked bit is reconstructed following the normal reconstruction procedure. After reconstruction of the parity bit, the reconstruction scheduler may update the reconstruction bitmap and set the bit associated with the reconstructed parity bit to 1. If the 1st bit value of the reconstruction bitmap is already a 1, the reconstruction scheduler may skip the current parity stripe (for example, the 1st parity stripe) and proceed to check the 2nd bit value to see if the parity stripe associated with the 2nd bit of the reconstruction bit map (2nd stripe), has been reconstructed already. That is, the reconstruction scheduler may continue and repeat this process until the last bit in the bitmap, assuming there is no interruption such a sent request from one or more applications.

2. In exemplary embodiments, if there is a request sent out from an application to access the failed drive during the above mentioned process, based on a priority setting of the RAID system the reconstruction scheduler may first complete the reconstruction of a currently selected checked parity stripe first, and then allow the system to serve the requesting application. For example, if the requesting application needs to write data to the failed drive, the reconstruction schedule may write directly to the replacement drive and update then update the reconstruction bitmap to indicate that the corresponding parity stripe has been reconstructed. If the requesting, application needs to read data from a failed drive but the data has not been reconstructed yet, the reconstruction scheduler may issue a command to reconstruct the data by reading from other available drives in the RAID group and reconstruct the data on the fly. The reconstruction scheduler may then write the data to the replacement drive and update the reconstruction bitmap of the corresponding reconstruction stripe to 1 to indicate that the stripe has been reconstructed. The bitmap can allow the reconstruction scheduler to avoid reconstructing a parity stripe again.

3. By checking the bitmap, the system can easily check with particular data the application requests to read has been reconstructed or not. If the data have already been reconstructed, the data may be read out directly from the replacement drives and sent back to the requesting application.

In accordance with exemplary embodiments, in a RAID system with hybrid drives, similar to a RAID system with conventional HDDs, the aforementioned methods may be used.

1. In accordance with exemplary embodiments, in a RAID system with hybrid drives, when a hybrid drive fails, the system may first to identify whether the NVM of the failed hybrid drive can be accessed or not. If yes, the data in the NVM may be read out and directly copied to a NVM of replacement hybrid drive. After copying has finished, the reconstruction bitmap may be updated by setting the bit values corresponding to the copied data to 1 s.

In accordance with exemplary embodiments, in a RAID system with hybrid drives, priority reconstruction may be scheduled based on data in the NVMs. For example, if all the data required for reconstruction is available in the NVMs of available hybrid drives, the parity stripes with high priority are reconstructed and then after the corresponding bit value in the reconstruction bitmap can be updated to 1. If only partial data is available, other remaining portion of the required data for reconstruction not in the NVM can be prefetched or caused to be prefetched to the NVMs. Once the necessary data is in the NVMs, the scheduler can schedule to reconstruct these parity stripes.

In accordance with exemplary embodiments, before data reconstruction in a RAID system, bitmaps may be built or generated, for example, a reconstruction bitmap and a space bitmap. As previously disclosed, in the reconstruction bitmap, each bit may represent the reconstruction status of a parity stripe. After generation, the bits in the reconstruction bitmap may be initialized to be all-zero. Thus when a parity stripe is reconstructed, its corresponding bit may be set to 1.

In a space bitmap, in which each bit may represent whether a parity stripe (or a group of parity stripes) is used/allocated or not. If a parity stripe was used or allocated, a data reconstruction process such as one disclosed herein may be implemented. If a parity stripe was not previously used or allocated, reconstructing the parity stripe may be accomplished by simply writing zero to the replacement disk.

In accordance with exemplary embodiments, a space bitmap may be generated. For each parity/reconstruction stripe, the associated parity block can be checked. For example if it is an all-zero block, then it can be indicated as unused in the bitmap (e.g. “0”); otherwise, it may be indicated it as used (e.g., “1”). During initialization, all the data and parity block in a RAID system may initialized to zero blocks. Thus, if a parity stripe is subsequently used, then its parity block must be updated and become non-zero. If a parity stripe is never used, its parity block must remain to be an all-zero block.

In accordance with some exemplary embodiments, a space bitmap may be avoided or not used. Instead, parity-block checking may be implemented on the fly during reconstruction, and a space bitmap is not needed to record or indicate unused space. For example, before reconstructing each parity stripe, first the parity block is checked. If the parity block is all zero, this parity stripe is reconstructed by writing 0 to the replacement disk; otherwise, it is reconstructed.

In accordance with exemplary embodiments, the various exemplary RAID systems disclosed herein may include and/or be operatively coupled to one or more computing devices not shown. The computing devices may, for example, include one or more processors and other suitable components such as memory and computer storage. For example, at least one RAID controller included with a RAID system and may be operatively connected to the storage drives constituting the RAID system. It should be understood that processor may also comprise other forms of processors or processing devices, such as a microcontroller, or any other device that can be programmed to perform the functionality described herein.

Accordingly, the computing devices may execute software so as to implement, at least in part one or more of various methods, or aspects thereof, disclosed herein such as the reconstruction scheduler processes, various input/output requests, etc. Such software may be stored on any appropriate or suitable non-transitory computer readable media so as to be executed by a processor(s). In other words, the computing devices may interact or interface with the various drives of the RAID systems disclosed herein. Accordingly, the computing devices may be used to create, update, access, etc., the tables disclosed herein (e.g., the space bitmap, the reconstruction bitmap, etc.). The tables may be stored as data in any suitable storage device, such as in any suitable computer storage device or memory.

In accordance with exemplary embodiments, a method for data reconstruction in a RAID storage system that includes a plurality of storage drives, one of which that has failed, may include: selecting for reconstruction, a parity stripe from a plurality of parity stripes for reconstruction; determining whether the selected parity stripe for reconstruction has been previously reconstructed by checking a reconstruction table, the reconstruction table comprising entries each indicating a reconstruction status corresponding to at least one of the plurality of parity stripes for reconstruction, wherein each reconstruction status indicates whether or not the at least one corresponding parity stripe has been previously reconstructed; determining whether the selected parity stripe has been previously allocated by checking a space table, the space table comprising entries indicating an allocation status corresponding to at least one of the plurality of parity stripes for reconstruction, wherein the allocation status indicates whether or not the at least one corresponding parity stripe has been previously allocated; and if the selected parity stripe has been determined to not have been previously reconstructed and if the selected parity stripe has been determined to have been previously allocated, the method further comprises reconstructing the selected parity stripe in a replacement disk and updating the reconstruction status in the reconstruction table corresponding to selected parity stripe to indicate that the selected stripe has been reconstructed.

In accordance with exemplary embodiments, the method may further include writing a zero to the replacement disk for data corresponding to the selected parity stripe, if the selected parity stripe has been determined to not have been previously allocated.

In accordance with exemplary embodiments, the method may further include receiving an input/output request for data associated with a parity stripe before the selecting of a parity stripe; and wherein the selecting of a parity stripe includes selecting the parity stripe to which the input/output request for data is associated. In accordance with exemplary embodiments, if no input/output operation request is received, the selecting of a parity stripe may include selecting a parity stripe corresponding to a first entry of the reconstruction table that indicates reconstruction has not occurred. In accordance with exemplary embodiments, the reconstruction table may be a bitmap including a plurality of bits, each bit representing a reconstruction status of each of the plurality of parity stripes for reconstruction.

In accordance with exemplary embodiments, the space table may be a bitmap including a plurality of bits, each bit representing the reconstruction status of each of the plurality of parity stripes for reconstruction.

In accordance with exemplary embodiments, the method may further include selecting an additional parity stripe from the plurality of parity stripes for reconstruction.

In accordance with exemplary embodiments, the method may further include executing the received input/output request.

In accordance with exemplary embodiments, each of the plurality of storage drives may be a hard disk drive.

In accordance with exemplary embodiments, each of the plurality of storage drives may be a hybrid drive that includes a non-volatile memory (NVM) and a magnetic disk media. In accordance with exemplary embodiments, the method may further include determining whether data of a NVM of the failed drive is accessible before the selecting of a parity stripe for reconstruction; and copying the data from the NVM of the failed hybrid drive to a NVM of a replacement hybrid drive if the NVM of the failed hybrid drive is determined to be accessible.

In accordance with exemplary embodiments, the method may further include before the selecting of a parity stripe for reconstruction, identifying one or more parity stripes for reconstruction that all of its parity blocks needed for reconstruction stored in the NVMs of non-failed disks and reconstructing the one or more identified parity stripe in a replacement disk.

In accordance with exemplary embodiments, the method may further include before the selecting of a parity stripe for reconstruction, identifying one or more additional parity stripes for reconstruction, the one or more additionally identified parity stripes having a portion of parity blocks associated with the parity stripe stored in the one or more NVMs of non-failed hybrid drives and a portion of the parity blocks stored in the magnetic disk media of the non-failed hybrid drives; instructing one or more of the non-failed hybrid drives to fetch the portion parity blocks associated with the identified parity stripes from the magnetic disk media of the non-failed hybrid drive and store in the respective NVM cache of the non-failed hybrid drives; and reconstructing the one or more identified additional parity stripes in a replacement disk.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for data reconstruction in a RAID storage system comprising a plurality of storage drives, one of which that has failed, the method comprising:
selecting for reconstruction, a parity stripe from a plurality of parity stripes for reconstruction;
determining whether the selected parity stripe for reconstruction has been previously reconstructed by checking a reconstruction table, the reconstruction table comprising entries each indicating a reconstruction status corresponding to at least one of the plurality of parity stripes for reconstruction, wherein each reconstruction status indicates whether or not the at least one corresponding parity stripe has been previously reconstructed;
determining whether the selected parity stripe has been previously allocated by checking a space table, the space table comprising entries indicating an allocation status corresponding to at least one of the plurality of parity stripes for reconstruction, wherein the allocation status indicates whether or not the at least one corresponding parity stripe has been previously allocated; and
if the selected parity stripe has been determined to not have been previously reconstructed and if the selected parity stripe has been determined to have been previously allocated, the method further comprises reconstructing the selected parity stripe in a replacement disk and updating the reconstruction status in the reconstruction table corresponding to selected parity stripe to indicate that the selected stripe has been reconstructed.

2. The method of claim 1, further comprising
if the selected parity stripe has been determined to not have been previously allocated, writing a zero to the replacement disk for data corresponding to the selected parity stripe.

3. The method of claim 1, further comprising, before the selecting of a parity stripe, receiving an input/output request for data associated with a parity stripe; and
wherein the selecting of a parity stripe comprises selecting the parity stripe to which the input/output request for data is associated.

4. The method of claim 3, wherein if no input/output operation request is received, the selecting of a parity stripe comprises selecting a parity stripe corresponding to a first entry of the reconstruction table that indicates reconstruction has not occurred.

5. The method of claim 1, wherein the reconstruction table comprises a bitmap comprising a plurality of bits, each bit representing a reconstruction status of each of the plurality of parity stripes for reconstruction.

6. The method of claim 1, wherein the space table comprises a bitmap comprising a plurality of bits, each bit representing the reconstruction status of each of the plurality of parity stripes for reconstruction.

7. The method of claim 1, further comprising, selecting an additional parity stripe from the plurality of parity stripes for reconstruction.

8. The method of claim 3, further comprising, executing the received input/output request.

9. The method of claim 1, wherein each of the plurality of storage drives comprises hard disk drive.

10. The method of claim 1, wherein each of the plurality of storage drives comprises a hybrid drive, each of the hybrid drives comprising a non-volatile memory (NVM) and a magnetic disk media.

11. The method of claim 10, further comprising,
before the selecting of a parity stripe for reconstruction:
determining whether data of a NVM of the failed drive is accessible; and
copying the data from the NVM of the failed hybrid drive to a NVM of a replacement hybrid drive if the NVM of the failed hybrid drive is determined to be accessible.

12. The method of claim 10, before the selecting of a parity stripe for reconstruction, the method further comprising:
identifying one or more parity stripes for reconstruction that all of its parity blocks needed for reconstruction stored in the NVMs of non-failed disks.

13. The method of claim 12, further comprising:
reconstructing the one or more identified parity stripe in a replacement disk.

14. The method of claim 12, further comprising:
identifying one or more additional parity stripes for reconstruction, the one or more additionally identified parity stripes having a portion of parity blocks associated with the parity stripe stored in the one or more NVMs of non-failed hybrid drives and a portion of the parity blocks stored in the magnetic disk media of the non-failed hybrid drives;
instructing one or more of the non-failed hybrid drives to fetch the portion parity blocks associated with the identified parity stripes from the magnetic disk media of the non-failed hybrid drive and store in the respective NVM cache of the non-failed hybrid drives.

15. The method of claim 14, the method further comprising
reconstructing the one or more identified additional parity stripes in a replacement disk.
